(19) United States
(12) Patent Application Publication
(10) Pub. No.: US 2022/0041947 A1
(43) Pub. Date: Feb. 10, 2022

(54) COCONUT SHELL CHARCOAL LOG

(71) Applicant: Britt Reynolds, Nakhon Ratchasima (TH)

(72) Inventor: Britt Reynolds, Nakhon Ratchasima (TH)

(21) Appl. No.: 16/984,153

(22) Filed: Aug. 4, 2020

(51) Int. Cl. C10L 5/44; C10L 5/22; C10L 5/28; C10L 5/36

(52) U.S. Cl. CPC C10L 5/44; C10L 5/22; C10L 5/28; C10L 5/365; C10L 2200/0469; C10L 2290/06; C10L 2290/28; C10L 2290/30; C10L 2290/08; C10L 2290/02

(57) ABSTRACT

A method for fabricating a coconut shell heat producing device. Heat is applied to coconut shells to form carbonized coconut charcoal pieces. The charcoal pieces are ground to form coconut charcoal powder. A moistened blend is created that includes the coconut charcoal powder, a binder and water. The moistened blend is placed into a press. Pressure is applied in the press to form the moistened blend into the heat providing device. The heat providing device includes at least one hole extending through the device. In a preferred embodiment the heat producing device is a coconut shell charcoal log.

The present invention relates to heat producing devices, and in particular, to charcoal heat producing devices.

### BACKGROUND OF THE INVENTION

Problems Associated with Wood Burning and Deforestation Wood causes smoke when burned, within the smoke there are a large number of poisons not only bad for humans but the environment as well. Each year, about 3,000 people die in residential fires in the U.S.—mainly from smoke inhalation. Woodsmoke is the most toxic type of air pollution in most cities, more dangerous than automobile and most industrial pollution. Lighting a wood fire in your house is like starting up your own toxic incinerator. Lifetime cancer risk is 12 times greater for woodsmoke compared to an equal volume of secondhand cigarette smoke. Burning 10 lbs. of wood for one-hour releases as much polycyclic aromatic hydrocarbons as 6,000 packs of cigarettes. Toxic, free radical chemicals in woodsmoke are biologically active 40 times longer than the free radicals in cigarette smoke. Woodsmoke is the third largest source of dioxins, one of the most intensely toxic compounds known to science.

More than 10,000 hectares of wood were illegally deforested in a few decades in many countries. Many third world countries where “Hardwoods” are grown, are being deforested daily. This deforestation has drastic consequences on the environment because these forest areas have a key role for biodiversity. Moreover, forests play a crucial role in the fight against global warming. In the event of mudslides or floods, the woods, hedges and other green areas act as a barrier.

### Carbonization

Carbonization is the production of charred carbon from a source material. The process is generally accomplished by heating the source material usually in the absence or limited amount of air to a temperature sufficiently high to dry and volatilize substances in the carbonaceous material. Coconut shells are cheap and readily available in high quantity. Coconut shell contains about 60-70% volatile matter and moisture which are removed largely during the carbonization process. The cellulosic structure of the coconut shell determines the end product. Coconut-shell-based activated carbon has unique properties as a superior adsorbent, making it the carbon of choice for many applications. It has been recognized that for an effective activated carbon the preliminary carbonization process is very essential. Therefore, parameters such as temperature, particle size and resident time for carbonization will affect the overall texture, quality and quantity of the carbonized product with the attendant effects on the ash, moisture, metal contents, and clean efficient heat production. An advantage of using coconut shells is that there is no cutting of trees or adding to the pollutants caused by wood burning.

What is needed is a better, non-wood burning device for cleanly producing heat.

### SUMMARY OF THE INVENTION

The present invention provides a method for fabricating a coconut shell heat producing device. Heat is applied to coconut shells to form carbonized coconut charcoal pieces. The charcoal pieces are ground to form coconut charcoal powder. A moistened blend is created that includes the coconut charcoal powder, a binder and water. The moistened blend is placed into a press. Pressure is applied in the press to form the moistened blend into the heat providing device. The heat providing device includes at least one hole extending through the device. In a preferred embodiment the heat producing device is a coconut shell charcoal log.

### BRIEF DESCRIPTION OF THE DRAWINGS

FIG. 1 shows a flowchart depicting a preferred embodiment of the present invention.

FIG. 2A shows a perspective view of a first preferred embodiment of the present invention.

FIG. 2B shows a side view of a first preferred embodiment of the present invention.

FIG. 2C shows a top view of a first preferred embodiment of the present invention.

FIG. 2D shows a end view of a first preferred embodiment of the present invention.

FIG. 3A shows a perspective view of a second preferred embodiment of the present invention.

FIG. 3B shows a side view of a second preferred embodiment of the present invention.

FIG. 3C shows a top view of a second preferred embodiment of the present invention.

FIG. 3D shows a end view of a second preferred embodiment of the present invention.

### DETAILED DESCRIPTION OF THE PREFERRED EMBODIMENTS

The present invention provides heat providing elements fabricated from coconut shells. In a preferred embodiment the heat providing elements are coconut shell charcoal logs. These logs may be used for heating, visual enjoyment and cooking. One major advantage of the utilization of coconut shell charcoal logs is that wood burning and deforestation is avoided, thereby providing an extraordinary benefit to the environment and health of the people of the planet.

### Preferred Method for Fabricating Coconut Shell Charcoal Logs

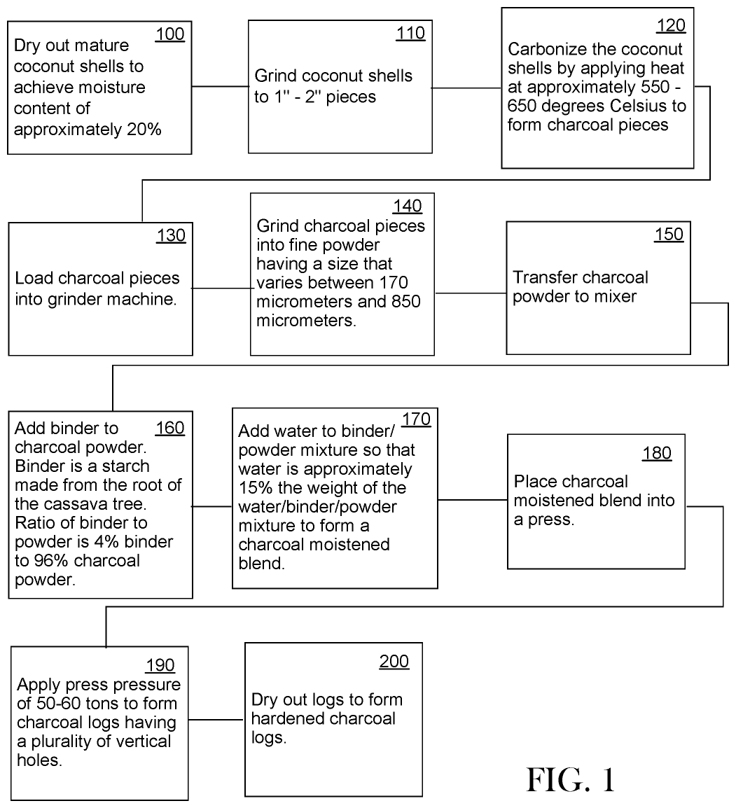

FIG. 1 shows a preferred method for fabricating coconut shell charcoal logs.

Mature coconut shells are first dried out (Step 100) so they have a moisture content of approximately 20%. Then the shells are ground to approximately 1-2 inch pieces (Step 110). The small coconut shell pieces are placed into brick kilns for the partial combustion process, also known as carbonization. The kilns are partially underground. The surrounding soil helps to reduce the fire and keeps the air levels down for a slow smoldering burn. Prior to heating the coconut pieces, a worker bricks up the kiln door. He seals the doors with mud instead of cement so as to allow the door to be dismantled later without ruining the bricks so that they are preserved for use in the next burn.

From the top of the kiln a worker ignites the fire using soft wax as starter material. The coconut shell pieces are heated to a temperature of approximately 550-650 degrees Celsius (1022-1202 degrees Fahrenheit) (Step 120). This allows the shells to be carbonized but not reduced to ash. Because of the limited air in the kilns the fire burns out after 20-24 hours. The worker takes the door apart and rakes the charred remains of the coconut shells into a basket. The carbonization process has converted the remains of the coconut shells into a rich charcoal. The worker heaps the blackened shells into a pile and places the pile into the sun. Under the sun's rays, moisture from the water used to extinguish any hot spots evaporates. The charcoal dries out and becomes easy to break. The coconut shell charcoal pieces are now ready to be processed into logs.

Workers load the charcoal pieces into grinder machines (Step 130). Inside the grinder machines rollers pulverize the charcoal reducing it to a fine powder (Step 140). In a preferred embodiment the powder includes particles that may vary in size between 170 micrometers and 850 micrometers. For example, in one preferred embodiment ⅓ of the particles have a size of 170 micrometers and ⅔ of the particles have a size of 850 micrometers. The powder pours from the grinder machines into bins below the grinder machines. A worker transfers the charcoal powder to a mixer (Step 150).

In the mixer, binder is added to the charcoal powder (Step 160). In a preferred embodiment the binder is a starch is made from the root of the cassava tree. Preferably, the ratio of binder to powder is 4% binder to 96% powder. Water is then added to the binder/powder mixture (Step 170) to form a moistened blend. The water is preferably approximately 15% of the weight of the moistened blend. Together with water the binder binds the charcoal particles together like glue. The mixer whisks it all together like pastry. The consistency is ideal when the particles form clumps when pressed together.

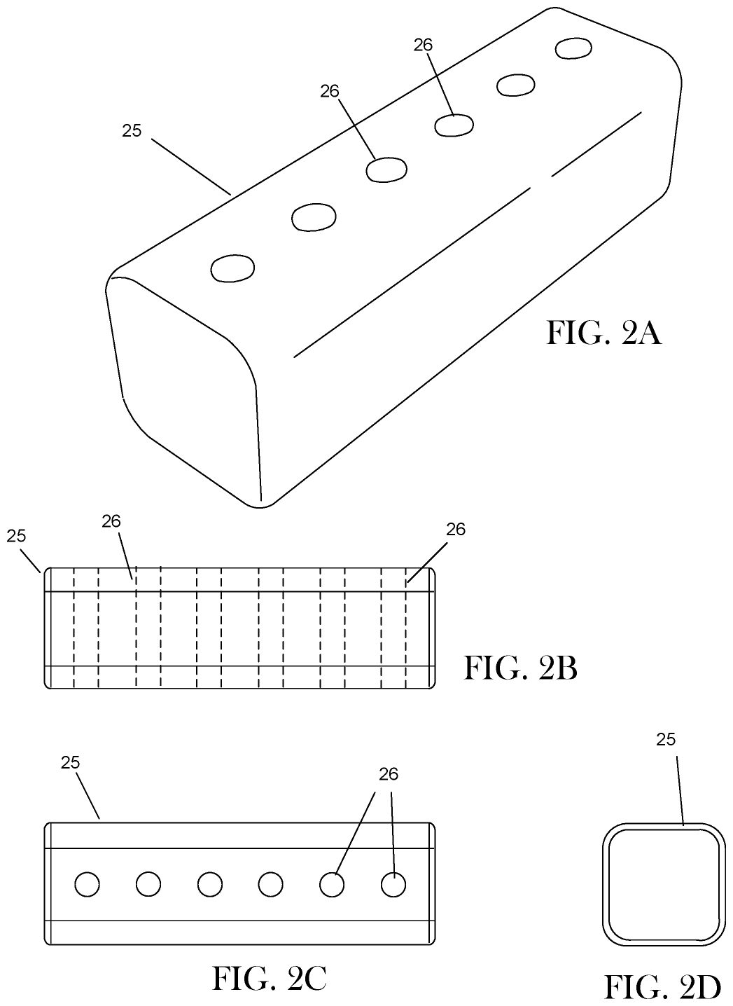

The moistened blend exits the mixer and spills into a bin. The next worker loads the charcoal blend through a mold and into a press (Step 180). In a preferred embodiment the press pressure is at 50-60 tons on a 150-ton press (Step 190). In one preferred embodiment, the press forms log 25 as shown in FIG. 2. Log 25 includes multiple 2 cm vertical holes 26 extending through log 25, as shown. Vertical holes 26 allows for optimum air flow and efficient and even, long burning with high heat distribution. In the preferred embodiment shown, log 25 is approximately 32 cm×10 cm×10 cm.

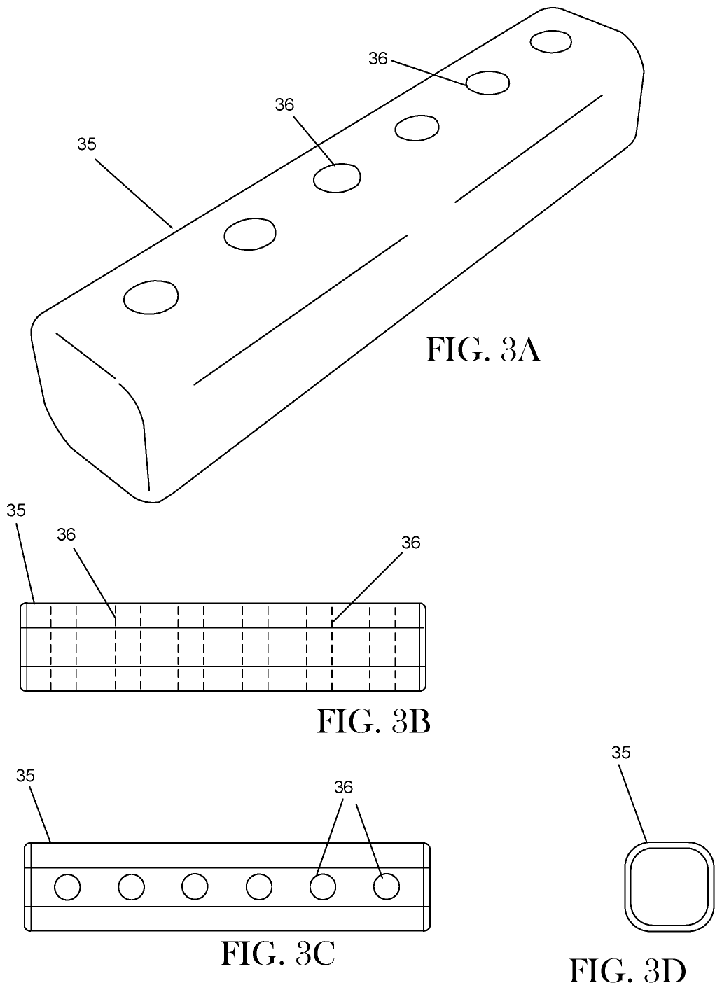

In another preferred embodiment, the press forms log 35 as shown in FIG. 3. Log 35 includes multiple 2 cm vertical holes 36 extending through log 35, as shown. Vertical holes 36 allows for optimum air flow and efficient and even, long burning with high heat distribution. In the preferred embodiment shown, log 35 is approximately 31.75 cm×7 cm×7 cm.

In one preferred embodiment the logs are put into a bio gas dryer for drying (Step 200). Or, the logs may be dried in the sun. Or, in another preferred embodiment, the logs may be dried after being placed in a drying enclosure having open fires in the center. In this preferred embodiment, the doors to the drying enclosure are closed, leaving the logs to bake for approximately 24 hours. During the drying process, heat fuses the charcoal particles together and the logs harden. Once dried the logs are solid to the touch and clean with no sooty residue.

### Some Advantages of Coconut Shell Charcoal Logs

Coconut charcoal logs 25 and 35 provide many advantages. Some of these are listed below.

Logs 25 and 35 are easy to light. They provide high heat, clean air, no sparks and very low risk of chimney fires. They provide 3-4 hours of flames. They produce low ash and are easy to clean when finished. High heat from logs 25 and 35 are provided up to 8 hours after being lighted. Logs 25 and 35 are reusable.

It should also be noted that although the above embodiments disclosed the fabrication of coconut shell charcoal logs, it would also be possible to press the moistened blend into other shapes. For example, the moistened blend could be pressed into much smaller briquettes that could be utilized for grill cooking. The advantage of a small briquette is that it will ash over quicker for faster cooking result.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

1. A method for fabricating a coconut shell charcoal heat providing device, comprising the steps of:
A. applying heat to coconut shells to form carbonized coconut charcoal pieces,
B. grinding said carbonized coconut charcoal to form coconut charcoal powder,
C. creating a moistened blend, comprising:
a. said coconut charcoal powder,
b. binder, and
c. water,
D. placing said moistened blend into a press, and
E. applying pressure in said press to form said moistened blend into said heat providing device, wherein said heat providing device comprises at least one hole extending through said heat providing device.

2. The method as in claim 1, wherein said coconut shell heat providing device is a coconut shell charcoal log.

3. The method as in claim 1, wherein said charcoal powder has a size that varies between approximately 170 micrometers and 850 micrometers.

4. The method as in claim 2 further comprising the step of drying out said coconut shell charcoal log to form a hardened coconut shell charcoal log.

5. The method as in claim 1, wherein said at least one hole is a plurality of holes.

6. The method as in claim 4, wherein the diameter of each said hole is 2 cm.

7. The method as in claim 5, wherein said coconut shell charcoal log has dimensions of approximately 32 cm×10 cm×10 cm.

8. The method as in claim 5, wherein said coconut shell charcoal log has dimensions of approximately 31.75 cm×7 cm×7 cm.

9. The method as in claim 1, wherein said moistened blend comprises
a. approximately 96% coconut charcoal powder, and
b. approximately 4% binder, and
c. up to 15% by weight of water.

10. The method as in claim 1, wherein said step of creating said carbonized coconut charcoal pieces is achieved by applying heat at approximately 550-650 degrees Celsius.

11. The method as in claim 1, wherein said binder is a starch fabricated from the root of the cassava tree.

12. A method for fabricating a coconut shell charcoal log, comprising the steps of:
A. applying heat at approximately 550-650 degrees Celsius to coconut shells to form carbonized coconut charcoal pieces,
B. grinding said carbonized coconut charcoal to form coconut charcoal fine powder of having a size that varies between approximately 170 micrometers and 850 micrometers,
C. creating a moistened blend, comprising a mixture of:
a. approximately 96% of said coconut charcoal powder,
b. approximately 4% of binder,
c. up to 15% by weight of water;
D. placing said moistened blend into a press,
E. applying pressure in said press to form said coconut shell charcoal log, wherein said coconut shell charcoal log comprises a plurality of holes extending through said coconut shell charcoal log, and
F. applying heat to dry out said coconut shell charcoal log to form a hardened coconut shell charcoal log.
